(19) United States
(12) Patent Application Publication
(10) Pub. No.: US 2012/0044321 A1
(43) Pub. Date: Feb. 23, 2012

(54) APPARATUS AND METHOD FOR MONITORING BROADCASTING SERVICE IN DIGITAL BROADCASTING SYSTEM

(75) Inventors: Byung-Jun BAE, Daejeon (KR); Joung-Il YUN, Daejeon (KR); Kwang-Yong KIM, Daejeon (KR); Gwang-Soon LEE, Daejeon (KR); Yun-Jeong SONG, Daejeon (KR); Nam-Ho HUR, Daejeon (KR); Soo-In LEE, Daejeon (KR)

(73) Assignee: Electronics and Telecommunications Research Institute, Daejeon (KR)

(21) Appl. No.: 13/212,674

(22) Filed: Aug. 18, 2011

(30) Foreign Application Priority Data
Aug. 18, 2010 (KR) 10-2010-0079757
Aug. 10, 2011 (KR) 10-2011-0079580

(51) Int. Cl. H04N 13/00

(52) U.S. Cl. 348/42; 348/E13.06

(57) ABSTRACT

A broadcasting service monitoring apparatus includes: a stream separation unit to extract a partial stream from an inputted 3D stream and separate detailed stream configuration and service-related information and a stream for 3D video service from the 3D stream; a configuration information analysis unit to minutely analyze the separated service-related information and the separated stream for 3D video service; a 2D image decoding unit to decode the separated stream for 3D video service into a predetermined image; an image separation unit to separate one screen of the decoded predetermined image into two screens and generate two images; a 3D image reproduction unit to reproduce the generated two images; a depth information extraction unit to extract depth information for 3D video service from the generated two images; and a 3D information representation unit to represent the analyzed values and the extracted depth information.

### CROSS-REFERENCE TO RELATED APPLICATIONS

The present application claims priority of Korean Patent Application Nos. 10-2010-0079757 and 10-2011-0079580, filed on Aug. 18, 2010, which are incorporated herein by reference in their entirety.

### BACKGROUND OF THE INVENTION

1. Field of the Invention

Exemplary embodiments of the present invention relate to a broadcasting service monitoring apparatus and method in a digital broadcasting system; and, more particularly, to a broadcasting service monitoring apparatus and method in a digital broadcasting system, which is capable of analyzing and monitoring detailed information of a three-dimensional (3D) broadcasting service in real time, when a digital broadcasting system including terrestrial broadcasting, cable broadcasting, satellite broadcasting, and mobile broadcasting provides a 3D broadcasting service.

2. Description of Related Art

A digital broadcasting system including terrestrial broadcasting, cable broadcasting, satellite broadcasting, and mobile broadcasting has a variety of methods for providing a 3D broadcasting service. The digital broadcasting system may have structures illustrated in FIGS. 1A and 1B.

FIGS. 1A and 1B are diagrams simply illustrating the structure of a conventional digital broadcasting system for providing a 3D digital broadcasting service.

Referring to FIG. 1A, the digital broadcasting system for providing a 3D digital broadcasting service (hereinafter, referred to as ‘3D broadcasting service’) includes a 2D image providing unit 11, a 3D image and additional data providing unit 12, a multiplexing unit 13, a transmitting unit 14, a receiving unit 15, a demultiplexing unit 16, a 2D image reproducing unit 17, and a 3D image reproducing unit 18. The multiplexing unit 13 multiplexes a 2D image and a 3D image and additional data which are inputted from the 2D image providing unit 11 and the 3D image providing unit 12, respectively, and the transmitting unit 14 transmits the multiplexed data. Then, the receiving unit 15 receives the signal transmitted through the transmitting unit 14, the demultiplexing unit 16 demultiplexes the multiplexed images of the received signal, and the 2D image reproducing unit 17 and the 3D image reproducing unit 18 reproduce the images. Through the above-described process, the digital broadcasting system provides a 3D digital broadcasting service.

Referring to FIG. 1B, another conventional digital broadcasting system for providing a 3D broadcasting service includes an image synthesizing unit 21, a 2D image providing unit 22, a multiplexing unit 23, a transmitting unit 24, a receiving unit 25, a demultiplexing unit 26, an image separating unit 27, a 2D image reproducing unit 28, and a 3D image reproducing unit 29. The image synthesizing unit 21 synthesizes a 2D images, a 3D image, and additional data and inputs the synthesized images to the 2D image providing unit 22, the multiplexing unit 23 multiplexes the synthesized image, and the transmitting unit 24 transmits the multiplexed image. Then, the receiving unit 25 receives the signal transmitted through the transmitting unit 24, the demultiplexing unit 26 demultiplexes the multiplexed image of the received signal to provide to the image separating unit 27, the image separating unit 27 separates the demultiplexed image into the 2D image and the 3D image, and the 2D image reproducing unit 28 and the 3D image reproducing unit 29 reproduce the 2D image and the 3D image. Through the above-described process, the digital broadcasting system provides a 3D broadcasting service.

The digital broadcasting system as illustrated in FIG. 1A provides the additional data for 3D broadcasting service as a program separate from an existing 2D broadcasting service, such that backward compatibility with the 2D broadcasting service may be guaranteed to smoothly provide the 3D broadcasting service.

The digital broadcasting system as illustrated in FIG. 1B synthesizes two images using one program when constructing an image to provide a 3D broadcasting service, and the 3D receiver separates the synthesized image into two images to provide a 3D broadcasting service. In the digital broadcasting system, a current receiver for 2D broadcasting reproduces the images in such a shape that two images (left image and right image) are attached to each other. Therefore, the 3D broadcasting service in the current digital broadcasting system has a limit to providing backward compatibility with 2D broadcasting.

Meanwhile, in order for the digital broadcasting system to provide a 3D broadcasting service, configuration and service-related information for the 3D broadcasting service should be provided together with a video service. The current digital broadcasting system includes a variety of methods for providing 3D configuration information. For example, 3D configuration information may be contained in existing 2D configuration information and then provided, or separate 3D configuration information may be separately defined and then provided.

In particular, when the digital broadcasting systems illustrated in FIGS. 1A and 1B provides a 3D broadcasting service, data analyzed accurately for the 3D broadcasting service should be provided to a broadcasting system operator.

In the current digital broadcasting system, however, broadcasting program analyzers for analyzing a 3D broadcasting service are focused on 2D broadcasting. Therefore, it is difficult to analyze the above-described 3D broadcasting service. Accordingly, it is impossible to provide specific analysis data only for the 3D broadcasting service.

In particular, when the digital broadcasting system provides a 3D broadcasting service, depth information between two images (left image and right image) for making a viewer feel that the viewer is watching 3D broadcasting is necessarily required to provide the 3D broadcasting service. Therefore, a method for analyzing and monitoring a 3D broadcasting service in real time is required to provide the depth information.

### SUMMARY OF THE INVENTION

An embodiment of the present invention is directed to an apparatus and method for analyzing and monitoring a 3D broadcasting service to provide operation convenience to an operator in a digital broadcasting system, when the digital broadcasting system provides a 3D broadcasting service.

Another embodiment of the present invention is directed to an apparatus and method for analyzing and monitoring characteristics of 3D broadcasting, for example, detailed information of a 3D broadcasting service, which is not provided by a 2D broadcasting service monitoring apparatus.

Another embodiment of the present invention is directed to an apparatus and method for analyzing and monitoring a 3D broadcasting service in real time to provide information required when a digital broadcasting system provides a 3D broadcasting service.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a broadcasting service monitoring apparatus in a digital broadcasting system includes: a stream separation unit configured to extract a partial stream from an inputted 3D stream and separate detailed stream configuration and service-related information and a stream for 3D video service from the 3D stream, based on entire stream configuration information for the 3D stream; a configuration information analysis unit configured to minutely analyze the separated detailed stream configuration and service-related information and the separated stream for 3D video service; a 2D image decoding unit configured to decode the separated stream for 3D video service into a predetermined image; an image separation unit configured to separate one screen of the decoded predetermined image into two screens and generate two images; a 3D image reproduction unit configured to reproduce the generated two images; a depth information extraction unit configured to extract depth information for 3D video service from the generated two images; and a 3D information representation unit configured to represent the analyzed values of the service-related information and the 3D video service and the extracted depth information.

In accordance with another embodiment of the present invention, a broadcasting service monitoring apparatus in a digital broadcasting system includes: a stream separation unit configured to extract a partial stream from an inputted 3D stream and separate detailed stream configuration and service-related information, a 2D video service stream, an image stream for 3D video service configuration, and an additional data stream from the 3D stream, based on entire stream configuration information on the 3D stream; a configuration information analysis unit configured to minutely analyze the separated detailed stream configuration and service-related information; a 2D image decoding unit configured to decode the separated 2D video service stream and generate a 2D image; a 3D additional image decoding unit configured to decode the separated image stream for 3D video service configuration and the separated additional data stream and generate an additional image; a 3D image reproduction unit configured to reproduce the generated 2D image and additional image; a depth information extraction unit configured to extract depth information from the generated 2D image and additional image or the separated additional data stream; and a 3D image representation unit configured to represent the analyzed values of the service-related information and the 3D video service and the extracted depth information.

In accordance with another embodiment of the present invention, a broadcasting service monitoring method in a digital broadcasting system includes: receiving a 3D stream, extracting a partial stream from the 3D stream, and analyzing entire stream configuration information for the 3D stream; separating the 3D stream based on the entire stream configuration information; analyzing the separated 3D stream minutely and generating an analyzed value; decoding the separated 3D stream and generating a predetermined image; extracting depth information from the generated image; and representing the analyzed value and the extracted depth information and reproducing the predetermined image.

### BRIEF DESCRIPTION OF THE DRAWINGS

FIGS. 1A and 1B are diagrams simply illustrating the structure of a conventional digital broadcasting system for providing a 3D digital broadcasting service.

FIGS. 2 and 3 are diagrams schematically illustrating the architecture of a broadcasting service monitoring apparatus in a digital broadcasting system in accordance with an embodiment of the present invention.

FIG. 4 is a diagram schematically illustrating the configuration of a configuration information analysis unit in the broadcasting service monitoring apparatus in a digital broadcasting system in accordance with the embodiment of the present invention.

FIG. 5 is a diagram schematically illustrating the configuration of a 3D information representation unit in the broadcasting service monitoring apparatus in a digital broadcasting system in accordance with the embodiment of the present invention.

FIG. 6 is a flow chart showing a 3D broadcasting service monitoring method in a digital broadcasting system in accordance with another embodiment of the present invention.

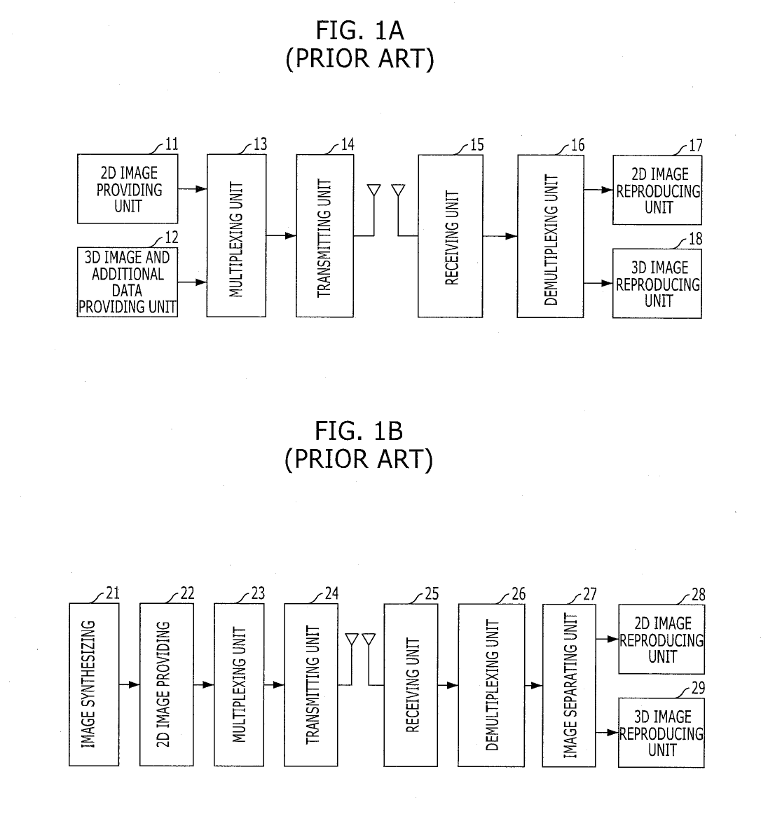

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Exemplary embodiments of the present invention provide an apparatus and method for analyzing and monitoring a 3D broadcasting service in real time to provide a variety of high-quality 3D broadcasting services in a digital broadcasting system. In the embodiments of the present invention, characteristics of 3D broadcasting, that is, detailed information of a 3D broadcasting service may be analyzed and monitored in real time, when the digital broadcasting system provides the 3D broadcasting service. Furthermore, the exemplary embodiments of the present invention provide a 3D broadcasting service monitoring apparatus and method for analyzing and monitoring detailed information on a 3D broadcasting service which is provided to a broadcasting system operator in real time, in order to effectively provide a variety of high-quality 3D broadcasting services. The 3D broadcasting service monitoring apparatus and method in the digital broadcasting system in accordance with the embodiments of the present invention may be commonly applied to a terrestrial broadcasting system, a cable broadcasting system, a satellite broadcasting system, and a mobile broadcasting system, and utilized for monitoring a received signal as well as a transmitted signal.

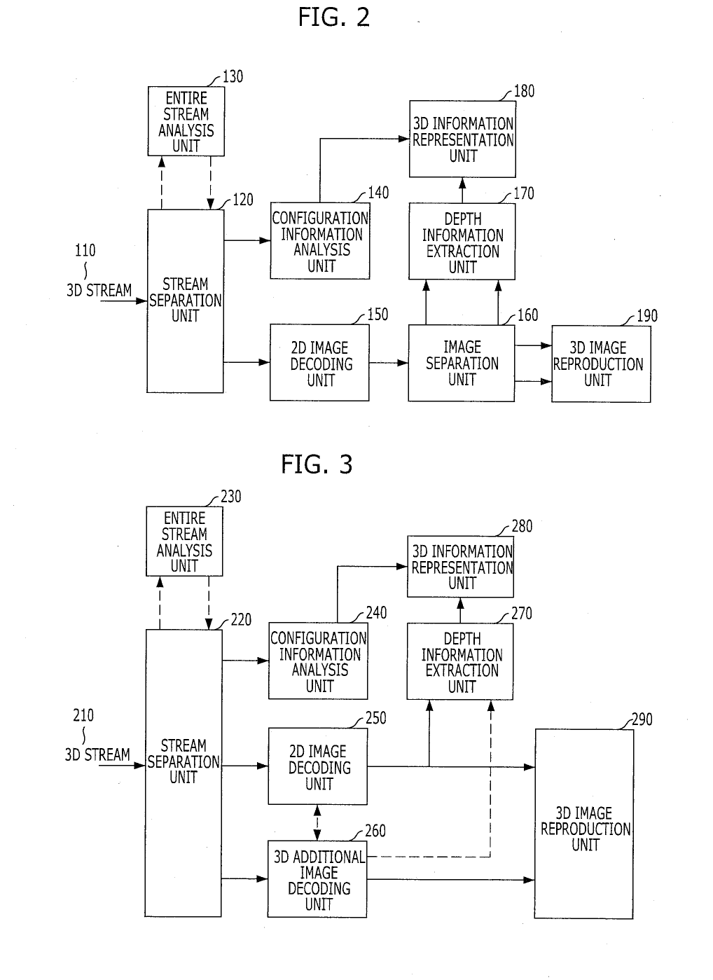

FIGS. 2 and 3 are diagrams schematically illustrating the architecture of a broadcasting service monitoring apparatus in a digital broadcasting system in accordance with an embodiment of the present invention. FIG. 2 is a block diagram of an apparatus for analyzing and monitoring a 3D stream having one image composed of two images in a digital broadcasting system, that is, an apparatus for analyzing and monitoring a 3D broadcasting service. FIG. 3 is a block diagram of an apparatus for analyzing and monitoring a 3D stream including a 2D image and an image for 3D configuration or additional data in a digital broadcasting system, that is, an apparatus for analyzing and monitoring a 3D broadcasting service.

In the digital broadcasting system in accordance with the embodiment of the present invention, a 3D stream inputted to the 3D broadcasting service monitoring apparatus is a 3D broadcasting stream for providing a 3D broadcasting service, and may include a 3D stream 110 having one image composed of two images, that is, a 3D image stream, or a 3D stream 210 having one 2D image and another image for 3D configuration or additional data, that is, a 3D image stream. The embodiment of the present invention provides the configuration diagrams of the 3D broadcasting service monitoring apparatuses in both cases. Furthermore, the inputted 3D streams 110 and 210 may include a stream which is extracted by a transmitter or a stream which is generated after an RF signal is received and demodulated by a receiver. That is, the 3D broadcasting service monitoring apparatus and method in the digital broadcasting system in accordance with the embodiment of the present invention may be utilized in the receiver as well as the transmitter.

First, referring to FIG. 2 which illustrates the apparatus configuration when the input steam 110 is a 3D stream having one image composed of two images, the 3D broadcasting service monitoring apparatus includes a stream separation unit 120, an entire stream analysis unit 130, a configuration information analysis unit 140, a 2D image decoding unit 150, an image separation unit 160, a depth information extraction unit 170, a 3D information representation unit 180, and a 3D image reproduction unit 190.

The 3D stream 110 having one image composed of two images is inputted to the stream separation unit 120, and the stream separation unit 120 extracts a partial stream through which the configuration of the entire stream may be recognized, from the inputted 3D stream, and transmits the extracted stream to the entire stream analysis unit 130.

The entire stream analysis unit 130 analyzes the entire stream configuration information on the inputted 3D stream 110 from the partial stream transmitted from the stream separation unit 120, and transmits the analyzed configuration information to the stream separation unit 120.

The stream separation unit 120 separates detailed stream configuration and service-related information and a stream for 3D video service from the inputted 3D stream, based on the above-described configuration information, and outputs the separated information to the next step.

Since the stream for 3D video service outputted from the stream separation unit 120 is one 3D stream having one image composed of two images, the 2D image decoding unit 150 decodes the stream for 3D video service in a similar manner to a general video image, and transmits the decoded stream to the image separation unit 160. The image separation unit 160 separates two images existing in one image and generates two complete images. The two images generated in such a manner are transmitted to the 3D image reproduction unit 190, and the 3D image reproduction unit 190 reproduces one 3D image or two 2D images such that an operator may monitor the images.

The depth information extraction unit 170 extracts depth information for 3D video service from the two images outputted from the image separation unit 160, and transmits the extracted depth information to the 3D information representation unit 180.

The configuration information analysis unit 140 minutely analyzes the detailed stream configuration and service-related information and the stream for 3D video service, which are transmitted from the stream separation unit 120, up to the field value level, and transmits the analyzed values to the 3D information representation unit 180.

The 3D information representation unit 180 represents the analyzed values of the service-related information and the 3D video service, which are transmitted from the configuration information analysis unit 140, and the depth information for 3D video service transmitted from the depth information extraction unit 170 in various manners, and provides the represented information to an operator.

Referring to FIG. 3 which illustrates the apparatus configuration when the input stream 210 is a 3D stream including one 2D image and another image for 3D configuration or additional data, the 3D broadcasting service monitoring apparatus includes a stream separation unit 220, an entire stream analysis unit 230, configuration information analysis unit 240, a 2D image decoding unit 250, a 3D additional image decoding unit 260, a depth information extraction unit 270, a 3D information representation unit 280, and a 3D image reproduction unit 290. The functions of the entire stream analysis unit 230, the configuration information analysis unit 240, the 3D information representation unit 280, and the 3D image reproduction unit 290 are similar or identical to those of the entire stream analysis unit 130, the configuration information analysis unit 140, the 3D information representation unit 180, and the 3D image reproduction unit 190 of FIG. 2.

Specifically, the 3D stream 210 including one 2D image and another image for 3D configuration or additional data is inputted to the stream separation unit 220.

The stream separation unit 220 separates detailed stream configuration and service-related information, a 2D video service stream, and an image stream for 3D video service configuration or additional data stream from the inputted 3D stream 210, based on entire stream configuration information transmitted from the entire stream analysis unit 230, and outputs the separated information to the next steps.

The entire stream configuration information is generated by the following process. When the stream separation unit 220 extracts a partial stream, through which the configuration of the entire stream may be recognized, from the inputted 3D stream 210 and transmits the extracted stream to the entire stream analysis unit 230, the entire stream analysis unit 230 analyzes the entire stream configuration information on the inputted 3D stream 210 from the partial stream and generates the entire stream configuration information. Furthermore, the detailed stream configuration and service-related information outputted from the stream separation unit 220 is transmitted to the configuration information analysis unit 240, in order to perform the function as described with reference to FIG. 2.

That is, the configuration information analysis unit 240 minutely analyzes the detailed stream configuration and service-related information transmitted from the stream separation unit 220 up to the field value level, and transmits the analyzed values to the 3D information representation unit 280. Furthermore, the 2D video service stream outputted from the stream separation unit 220 is transmitted to the 2D image decoding unit 250, and the 2D image decoding unit 250 decodes the 2D video service stream into a 2D image.

Furthermore, the image stream for 3D video service configuration or the additional data stream, which is outputted from the stream separation unit 220, is transmitted to the 3D additional image decoding unit 260. The 3D additional image decoding unit 260 exchanges information for 3D additional image decoding with the 2D image decoding unit 250, and generates an additional image for 3D image service. The 2D image decoded by the 2D image decoding unit 250 and the additional image generated by the 3D additional image decoding unit are transmitted to the 3D image reproduction unit 290, and the 3D image reproduction unit 290 reproduces one 3D image or two 2D images such that an operator may monitor the images.

The depth information extraction unit 270 extracts depth information from the 2D image transmitted from the 2D image decoding unit 250 and the additional image transmitted from the 3D additional image decoding unit 260 or extracts depth information from the additional data stream inputted to the 3D additional image decoding unit 260. The extracted depth information is transmitted to the 3D information representation unit 280, and the 3D information representation unit 280 represents the analyzed values of the service-related information and the 3D video service, which are transmitted from the configuration information analysis unit 240, and the depth information for 3D video service transmitted from the depth information extraction unit 270 in various manners, and provides the represented information to an operator.

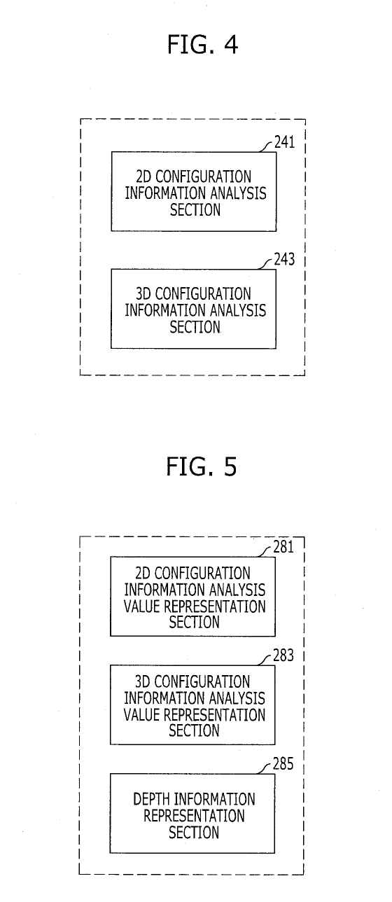

The configuration information analysis unit 140 of FIG. 2 and the configuration information analysis unit 240 of FIG. 3 include a 2D configuration information analysis section 241 and a 3D configuration information analysis section 243, as illustrated in FIG. 4. Furthermore, the 3D information representation unit 180 of FIG. 2 and the 3D information representation unit 280 of FIG. 3 include a 2D configuration information analysis value representation section 281, a 3D configuration information analysis value representation section 283, and a depth information representation section 285. FIG. 4 is a diagram schematically illustrating the configuration of the configuration information analysis unit in the broadcasting service monitoring apparatus in a digital broadcasting system in accordance with the embodiment of the present invention. FIG. 5 is a diagram schematically illustrating the configuration of the 3D information representation unit in the broadcasting service monitoring apparatus in a digital broadcasting system in accordance with the embodiment of the present invention.

As described above, the configuration information analysis unit analyzes the detailed stream configuration and service-related information and the stream for 3D video service, which are transmitted from the stream separation unit 120 or 220, up to the field value level. Referring to FIG. 4, the configuration information analysis unit includes the 2D configuration information analysis section 241 and the 3D configuration information analysis section 243. The 2D configuration information analysis section 241 minutely analyzes the detailed stream configuration and service-related information for 2D image from the 3D stream 110 or 210 transmitted from the stream separation unit 120 or 220, and the 3D configuration information analysis section 243 minutely analyzes the detailed stream configuration and service-related information for 3D image and the stream for 3D video service from the 3D stream 110 or 220 transmitted from the stream separation unit 120 or 220. Furthermore, the 2D configuration information analysis section 241 and the 3D configuration information analysis section 243 transmit the analyzed values to the 3D information representation unit 180 or 280.

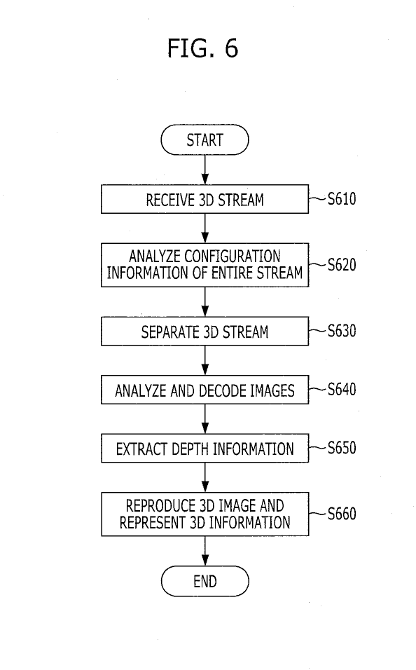

As described above, the 3D information representation unit represents the analyzed values of the service-related information and the 3D video service, which are transmitted from the configuration information analysis unit 140 or 240, and the depth information for 3D video service transmitted from the depth information extraction unit 170 or 270 in various manners. Referring to FIG. 5, the 3D information representation unit includes a 2D configuration information analysis value representation section 281, a 3D configuration information analysis value representation section 283, and a depth information representation section 285. The 2D configuration information analysis value representation section 281 represents the analyzed value for 2D image transmitted from the 2D configuration information analysis section 241 of the configuration information analysis unit 140 and 240. The 3D configuration information analysis value representation section 283 represents the analyzed value for 3D image transmitted from the 3D configuration information analysis section 243 of the configuration information analysis unit 140 or 240. The depth information representation section 285 represents the depth information for 3D video service transmitted from the depth information extraction unit 170 or 270. Now, referring to FIG. 6, the operation of analyzing and monitoring a 3D broadcasting service in a digital broadcasting system in accordance with the embodiment of the present invention will be described in more detail.

FIG. 6 is a flow chart showing a 3D broadcasting service monitoring method in a digital broadcasting system in accordance with another embodiment of the present invention.

Referring to FIG. 6, the 3D broadcasting service monitoring apparatus receives a 3D stream having one image composed of two images or a 3D stream having one 2D image and another image for 3D configuration or additional data, at step S610. Then, the 3D broadcasting service monitoring apparatus extracts a partial stream through which the configuration of the entire stream may recognized, from the received 3D stream, and analyzes the entire stream configuration information for the inputted 3D stream from the extracted partial stream, at step S620.

Then, at step S630, the 3D broadcasting service monitoring apparatus separates detailed stream configuration and service-related information, a 2D video service stream, and an image stream for 3D video service configuration or an additional data stream from the 3D stream, based on the configuration information. At this time, when the 3D stream is a 3D stream having one image composed of two images, the detailed stream configuration and service-related information and the stream for 3D video service are separated from the 3D stream, and when the 3D stream is a 3D stream having one 2D image and another image for 3D configuration or additional data, the detailed stream configuration and service-related information, the 2D vide service stream, and the image stream for 3D video service configuration or additional data stream are separated from the 3D stream.

At step S640, the 3D broadcasting service monitoring apparatus minutely analyzes the detailed stream configuration and service-related information for the 2D image in the 3D stream and minutely analyzes the detailed stream configuration and service-related information for 3D image and the stream for 3D video service in the 3D stream. Furthermore, the 3D broadcasting service monitoring apparatus decodes the 2D vide service stream and generates an additional image for 3D video service.

Here, when the 3D stream is a 3D stream having one image composed of two images, the stream for 3D video service is one 3D stream having one image composed of two images. Therefore, the stream for 3D video service is decoded in a similar manner to a general video image, and two images existing in one image are separated to generate two complete images. Furthermore, when the 3D stream is a 3D stream including one 2D image and another image for 3D configuration or additional data, the 2D video service stream is decoded into an 2D image, and the image stream for 3D video service configuration or additional stream is decoded to generate an additional image for 3D video service.

At step S650, the 3D broadcasting service monitoring apparatus extracts depth information for 3D video service from the two images generated through decoding, and extracts depth information from the decoded 2D image and the additional image or extracts depth information from the separated additional data stream.

At step S660, the 3D broadcasting service monitoring apparatus reproduces one 3D image or two 2D images and represents, the analyzed values of the service-related information and the 3D video service and the depth information for 3D video service in various methods.

As described above, the 3D broadcasting service monitoring apparatus and method in accordance with the embodiments of the present invention may provide analyzed information for 3D broadcasting services which are provided to a broadcasting system operator in real time, thereby effectively providing a variety of high-quality 3D broadcasting services in a digital broadcasting system.

In particular, the 3D broadcasting service monitoring apparatus and method may be applied to a case in which an inputted 3D stream includes one 2D image and another image for 3D configuration or additional data stream and a case in which an inputted 3D stream is a stream extracted by a transmitter or a stream generated after an RF signal is received and demodulated by a receiver as well as a case in which an inputted 3D stream is a stream having one image composed of two images. That is, the 3D broadcasting service monitoring apparatus and method in accordance with the embodiments of the present invention may be utilized for the receiver as well as the transmitter.

Furthermore, the 3D broadcasting service monitoring apparatus and method in accordance with the embodiment of the present invention may be applied to a terrestrial broadcasting system, a cable broadcasting system, a satellite broadcasting system, and a mobile broadcasting system, and utilized for monitoring a received signal as well as a transmitted signal.

In accordance with the embodiments of the present invention, it is possible to analyze and monitor a 3D broadcasting service in real time when a digital broadcasting system provides a 3D broadcasting service.

Accordingly, the digital broadcasting service may provide service operation convenience to 3D broadcasting service providers and broadcasting system operators, and thus may provide a variety of high-quality 3D broadcasting services to viewers.

While the present invention has been described with respect to the specific embodiments, it will be apparent to those skilled in the art that various changes and modifications may be made without departing from the spirit and scope of the invention as defined in the following claims.

What is claimed is:

1. A broadcasting service monitoring apparatus in a digital broadcasting system, comprising:
a stream separation unit configured to extract a partial stream from an inputted 3D stream and separate detailed stream configuration and service-related information and a stream for 3D video service from the 3D stream, based on entire stream configuration information for the 3D stream;
a configuration information analysis unit configured to minutely analyze the separated detailed stream configuration and service-related information and the separated stream for 3D video service;
a 2D image decoding unit configured to decode the separated stream for 3D video service into a predetermined image;
an image separation unit configured to separate one screen of the decoded predetermined image into two screens and generate two images;
a 3D image reproduction unit configured to reproduce the generated two images;
a depth information extraction unit configured to extract depth information for 3D video service from the generated two images; and
a 3D information representation unit configured to represent the analyzed values of the service-related information and the 3D video service and the extracted depth information.

2. The broadcasting service monitoring apparatus of claim 1, wherein the 3D stream comprises a 3D image stream having one image composed of two images.

3. The broadcasting service monitoring apparatus of claim 1, further comprising an entire stream analysis unit configured to analyze the entire stream configuration information from the partial stream and transmit the entire stream configuration information to the stream separation unit.

4. The broadcasting service monitoring apparatus of claim 1, wherein the 3D image reproduction unit reproduces one 3D image or two 2D images from the generated two images.

5. The broadcasting service monitoring apparatus of claim 1, wherein the configuration information analysis unit comprises:
a 2D configuration information analysis section configured to minutely analyze detailed stream configuration and service-related information for 2D image from the 3D stream up to a field value level; and
a 3D configuration information analysis section configured to minutely analyze detailed stream configuration and service-related information for 3D image and a stream for 3D video service from the 3D stream up to a field value level.

6. The broadcasting service monitoring apparatus of claim 5, wherein the 3D information representation unit comprises:
a 2D configuration information analysis value representation section configured to represent the analyzed value for 2D image;
a 3D configuration information analysis value representation section configured to represent the analyzed value for 3D image; and
a depth information representation section configured to represent the depth information for 3D video service.

7. A broadcasting service monitoring apparatus in a digital broadcasting system, comprising:
a stream separation unit configured to extract a partial stream from an inputted 3D stream and separate detailed stream configuration and service-related information, a 2D video service stream, an image stream for 3D video service configuration, and an additional data stream from the 3D stream, based on entire stream configuration information on the 3D stream;
a configuration information analysis unit configured to minutely analyze the separated detailed stream configuration and service-related information;
a 2D image decoding unit configured to decode the separated 2D video service stream and generate a 2D image;
a 3D additional image decoding unit configured to decode the separated image stream for 3D video service configuration and the separated additional data stream and generate an additional image;
a 3D image reproduction unit configured to reproduce the generated 2D image and additional image;
a depth information extraction unit configured to extract depth information from the generated 2D image and additional image or the separated additional data stream; and
a 3D image representation unit configured to represent the analyzed values of the service-related information and the 3D video service and the extracted depth information.

8. The broadcasting service monitoring apparatus of claim 7, wherein the 3D stream comprises a 3D image stream having one 2D image and another image for 3D configuration or additional data.

9. The broadcasting service monitoring apparatus of claim 7, further comprising an entire stream analysis unit configured to analyze the configuration information of the entire stream from the partial stream and transmit the configuration information of the entire stream to the stream separation unit.

10. The broadcasting service monitoring apparatus of claim 7, wherein the 3D image reproduction unit reproduces one 3D image or two 2D images from the generated two images.

11. The broadcasting service monitoring apparatus of claim 7, wherein the configuration information analysis unit comprises:
a 2D configuration information analysis section configured to minutely analyze detailed stream configuration and service-related information for 2D image from the 3D stream up to a field value level; and
a 3D configuration information analysis section configured to minutely analyze detailed stream configuration and service-related information for 3D image and a stream for 3D video service from the 3D stream up to a field value level.

12. A broadcasting service monitoring method in a digital broadcasting system, comprising:
receiving a 3D stream, extracting a partial stream from the 3D stream, and analyzing entire stream configuration information for the 3D stream;
separating the 3D stream based on the entire stream configuration information;
analyzing the separated 3D stream minutely and generating an analyzed value;
decoding the separated 3D stream and generating a predetermined image;
extracting depth information from the generated image; and
representing the analyzed value and the extracted depth information and reproducing the predetermined image.

13. The broadcasting service monitoring method of claim 12, wherein the 3D stream comprises a 3D image stream having one image composed of two images.

14. The broadcasting service monitoring method of claim 13, wherein, in said separating the 3D stream based on the entire stream configuration information, detailed stream configuration and service-related information and a stream for 3D video service are separated from the 3D stream, and
in said analyzing the separated 3D stream minutely and generating the analyzed value, detailed stream configuration and service-related information for 2D image is analyzed from the 3D stream up to a field value level, and detailed stream configuration and service-related information for 3D image and a stream for 3D video service are analyzed from the 3D stream up to a field value level.

15. The broadcasting service monitoring method of claim 14, wherein, in said decoding the separated 3D stream and generating the predetermined image, the separated stream for 3D video service is decoded into a predetermined image, and one screen of the decoded predetermined image is separated into two screens to generate two images.

16. The broadcasting service monitoring method of claim 15, wherein, in said extracting the depth information from the generated image, depth information for 3D video service is extracted from the generated two images, and
in said representing the analyzed value and the extracted depth information and reproducing the predetermined image, the analyzed values of the separated service-related information and the 3D video service and the depth information are represented, and one 3D image or two 2D images are reproduced from the generated two images.

17. The broadcasting service monitoring method of claim 12, wherein the 3D stream comprises a 3D image stream having one 2D image and another image for 3D configuration or additional data.

18. The broadcasting service monitoring method of claim 17, wherein, in said separating the 3D stream based on the entire stream configuration information, detailed stream configuration and service-related information, a 2D video service stream, an image stream for 3D video service configuration, and an additional data stream are separated from the 3D stream,
in said analyzing the separated 3D stream and generating the analyzed value, detailed stream configuration and service-related information for 2D image is minutely analyzed from the 3D stream up to a field value level, and detailed stream configuration and service-related information for 3D image and a stream for 3D video service are minutely analyzed from the 3D stream up to a field value level.

19. The broadcasting service monitoring method of claim 18, wherein, in said decoding the separated 3D stream and generating the predetermined image, the separated 2D vide service stream is decoded to generate a 2D image, and the separated image stream for 3D video service configuration and the separated additional data stream are decoded to generate an additional image.

20. The broadcasting service monitoring method of claim 19, wherein, in said extracting the depth information from the generated image, depth information is extracted from the generated 2D image and additional image or the separated additional data stream, and
in said representing the analyzed value and the extracted depth information and reproducing the predetermined image, the analyzed values of the separated service-related information and the 3D video service and the depth information are represented, and one 3D image or two 2D images are reproduced from the generated 2D image and additional image.
